(19) United States
(12) Patent Application Publication
(10) Pub. No.: US 2008/0084919 A1
(43) Pub. Date: Apr. 10, 2008

(54) Multiprotocol wireless communication apparatus and methods

(75) Inventors: Bendik Kleveland, Santa Clara, CA (US); David Friedman, Atherton, CA (US); Stanley B-T Wang, Cupertino, CA (US); Thomas H. Lee, Burlingame, CA (US); Carl Gyllenhammer, Scotts Valley, CA (US)

Correspondence Address: Edouard Garcia, 501 Palmer Lane, Menlo Park, CA, 94025, US

(73) Assignee: ZeroG Wireless, Inc.

(21) Appl. No.: 11/606,448

(22) Filed: Nov. 30, 2006

Related U.S. Application Data
(63) Continuation-in-part of application No. 11/543,508, filed on Oct. 5, 2006.

(51) Int. Cl. H04B 1/00

(52) U.S. Cl. 375/146

(57) ABSTRACT

In a wireless transmission method, an input data signal corresponding to a serial combination of a first transmit data signal and a second transmit data signal is received. The first and second transmit data signals are phase-modulated with different first and second spreading code signals to produce first and second DSSS transmit signals, which are serially output as a baseband transmit signal that is up-converted to a selected wireless transmission frequency range. The first and second phase-modulated signals are serially output as a baseband transmit signal. In a wireless reception method, an input receive signal is down-converted to a baseband receive signal corresponding to a serial combination of first and second time-interleaved DSSS receive signals in a baseband frequency range. The first and second DSSS receive signals are phase-demodulated with different first and second de-spreading code signals to produce first and second receive data signals.

### CROSS-REFERENCE TO RELATED APPLICATIONS

Under 35 U.S.C. § 120, this application claims the benefit of U.S. application Ser. No. 11/543,508, filed Oct. 5, 2006, the entirety of which is incorporated herein by reference.

### BACKGROUND

Wireless communications involve the transmission and reception of wireless signals. These communications may be one-way communications or two-way communications. Standard wireless communications modules have been developed to transition between the wireless transmission medium (usually air) and the electronic components inside wireless communication devices. A communications module may be integrally incorporated within a host system or a host system component (e.g., a network interface card (NIC)) or it may consist of a separate component that readily may be plugged into and unplugged from a host system. Communication modules include transmitter modules, receiver modules, and transceiver modules.

Each communications module produces a standardized output to the host device in accordance with a compatible wireless communications protocol. In general, a wireless communications protocol is any format, definition, or specification that specifies the content or nature of data that is transmitted or the link over which the data is transmitted. A wireless communications protocol typically includes transmission rate specifications, wireless link specifications, frame formats, blocking formats, text formats, stop/start indicators, framing and heading indicators, field definitions, checksum values, and carriage return and line feed (CRJLF) indicators. Many different wireless communications protocols have been developed. In the area of short-range wireless communications, Bluetooth and IEEE 802.11 wireless local area networking protocols recently have attracted the most interest.

With the proliferation of different wireless communications protocols, there has arisen a need for devices to communicate with a wide variety of wireless communication devices using different wireless communications protocols. This need coupled with the desire to reduce the size, power requirements, and cost have led to the development of single-chip transceivers that are capable of communicating in accordance with different wireless communications protocols. In one approach, a single chip includes a separate transceiver integrated circuit for each wireless communication protocol. In another approach, a single chip includes dual-mode transceiver circuits that can be selectively reconfigured to handle wireless communications in accordance with Bluetooth and IEEE 802.11 wireless local area networking protocols.

What are needed are apparatus and methods that are capable of communicating with multiple radio environments in accordance with different wireless communications protocols in implementations that have smaller size and power requirements and higher switching speeds.

### SUMMARY

In one aspect, the invention features a wireless communication apparatus that includes a spectrum spreading stage and an up-conversion stage. The spectrum spreading stage has a data signal input for receiving an input data signal corresponding to a serial combination of a first transmit data signal and a second transmit data signal. The spectrum spreading stage is operable to phase-modulate the first transmit data signal with a first spreading code signal to produce a first direct sequence spread spectrum (DSSS) transmit signal, phase-modulate the second transmit data signal with a second spreading code signal different from the first spreading code signal to produce a second DSSS transmit signal, and serially output the first and second DSSS transmit signals as a baseband transmit signal. The up-conversion stage is operable to up-convert the baseband transmit signal to an up-converted signal in a selected wireless transmission frequency range.

In another aspect, the invention features a wireless communication method, in accordance with which an input data signal corresponding to a serial combination of a first transmit data signal and a second transmit data signal is received. The first transmit data signal is phase-modulated with a first spreading code signal to produce a first direct sequence spread spectrum (DSSS) transmit signal. The second transmit data signal is phase-modulated with a second spreading code signal different from the first spreading code signal to produce a second transmit DSSS signal. The first and second DSSS transmit signals are serially output as a baseband transmit signal. The baseband transmit signal is up-converted to an up-converted signal in a selected wireless transmission frequency range.

In another aspect, the invention features a wireless communication apparatus that includes a down-conversion stage and a spectrum de-spreading stage. The down-conversion stage is operable to down-convert an input receive signal that includes a carrier in a first frequency range serially modulated with first and second time-interleaved DSSS receive signals to a baseband receive signal corresponding to a serial combination of the first and second time-interleaved DSSS receive signals in a baseband frequency range. The spectrum de-spreading stage has an input for receiving the baseband receive signal. The spectrum de-spreading stage is operable to phase-demodulate the first DSSS receive signal with a first de-spreading code signal to produce a first receive data signal and to phase-demodulate the second DSSS receive signal with a second de-spreading code signal different from the first de-spreading code signal to produce a second receive data signal.

In another aspect, the invention features a wireless communication method, in accordance with which an input receive signal that includes a carrier in a first frequency range serially modulated with first and second time-interleaved DSSS receive signals is down-converted to a baseband receive signal corresponding to a serial combination of the first and second time-interleaved DSSS receive signals in a baseband frequency range. The first DSSS receive signal is phase-demodulated with a first de-spreading code signal to produce a first receive data signal. The second DSSS receive signal is phase-demodulated with a second de-spreading code signal different from the first de-spreading code signal to produce a second receive data signal.

Other features and advantages of the invention will become apparent from the following description, including the drawings and the claims.

### DESCRIPTION OF DRAWINGS

FIG. 1 is a block diagram of an embodiment of a wireless transmitter communication apparatus that includes a spectrum spreading stage and an up-conversion stage in an exemplary operational environment.

FIG. 2 is a flow diagram of an embodiment of a wireless communication method.

FIG. 3 is a block diagram of an embodiment of the spectrum spreading stage shown in FIG. 1.

FIG. 4A is a block diagram of an embodiment of a phase modulation circuit.

FIG. 4B is a graph of an exemplary set of input signals that are applied to the phase modulation circuit of FIG. 4A and the resulting output signal produced by the phase modulation circuit.

FIG. 5 is a diagrammatic view of an exemplary chip sequence in an embodiment of a spreading code signal.

FIGS. 6A-6D are diagrammatic views of exemplary chip sequences in respective embodiments of spreading code signals.

FIG. 7 is a block diagram of a prior art chip sequence generator.

FIGS. 8A and 8B are diagrammatic views of exemplary chip sequences produced by the chip sequence generator of FIG. 7 in response to a clock signal with pulses occurring at two different respective clock rates.

FIG. 9 is a block diagram of an embodiment of an up-conversion stage that has a superheterodyne transmitter architecture.

FIG. 10 is a block diagram of an embodiment of an up-conversion stage that has a direct conversion transmitter architecture.

FIG. 11 is a block diagram of an embodiment of a wireless receiver communication apparatus that includes a down-conversion stage and a spectrum de-spreading stage in an exemplary operational environment.

FIG. 12 is a flow diagram of an embodiment of a wireless communication method.

FIG. 13 is a block diagram of an embodiment of a down-conversion stage that has a superheterodyne transmitter architecture.

FIG. 14 is a block diagram of an embodiment of a down-conversion stage that has a direct conversion transmitter architecture.

FIG. 15 is a block diagram of an embodiment of the spectrum de-spreading stage shown in FIG. 11.

FIG. 16 is a block diagram of an embodiment of a gain control stage coupled to an embodiment of the spectrum de-spreading stage shown in FIG. 15.

FIG. 17 is a block diagram of an embodiment of a wireless local area network that includes an access point, a mobile unit, and a peripheral.

FIGS. 18A and 18B are graphs of data rate plotted as a function of time illustrating different modes of communication between the mobile unit and the access point and between the mobile unit and the peripheral in the wireless local area network shown in FIG. 17.

FIG. 19 is a diagrammatic view of an embodiment of the local area network of FIG. 17.

FIGS. 20A and 20B are graphs of data rate plotted as a function of time illustrating different modes of communication between the mobile unit and the access point and between the mobile unit and the peripheral in the wireless local area network shown in FIG. 19.

FIG. 21 is a diagrammatic view of an embodiment of the local area network of FIG. 17.

FIGS. 22A and 22B are graphs of data rate plotted as a function of time illustrating different modes of communication between the mobile unit and the access point and between the access point and the peripheral in the wireless local area network shown in FIG. 21.

FIG. 23 is a diagrammatic view of an embodiment of the local area network of FIG. 17.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. OVERVIEW

The embodiments that are described herein are capable of communicating with multiple wireless environments in accordance with different wireless communications protocols. These embodiments are capable of transmitting and receiving signals that include time-interleaved data-carrying signals that conform to different wireless communications protocols. In particular, the time-interleaved data-carrying signals are direct sequence spread spectrum (DSSS) signals that are produced using different spreading code signals. Some embodiments leverage this feature in novel dual-mode transmitter and receiver architectures in which the same analog components are used to process the different data-carrying signals. In this way, these embodiments are efficient in their use of size and power resources and are able to achieve higher switching speeds relative to approaches that use separate or reconfigurable analog processing channels for the different data-carrying signals.

As used herein the term “wireless” refers to any form of non-wired signal transmission, including AM and FM radio transmission, TV transmission, cellular telephone transmission, portable telephone transmission, and wireless LAN (local area network) transmission. A wide variety of different methods and technologies may be used to provide wireless transmissions in the embodiments that are described herein, including infrared line of sight methods, cellular methods, microwave methods, satellite methods, packet radio methods, and spread spectrum methods.

The wireless communication apparatus that are described herein may be implemented by relatively small, low-power and low-cost integrated circuit stages that are integrated on a single semiconductor chip. As a result, these apparatus are highly suitable for incorporation in wireless communications environments that have significant size, power, and cost constraints, including but not limited to handheld electronic devices (e.g., a mobile telephone, a cordless telephone, a portable memory device such as a smart card, a personal digital assistant (PDA), a video camera, a still image camera, a solid state digital audio player, a CD player, an MCD player, a game controller, and a pager), portable computers (e.g., laptop computers), computer peripheral devices (e.g., input devices, such as computer mice), and other embedded environments.

### II. WIRELESS TRANSMITTER EMBODIMENTS

### A. Overview

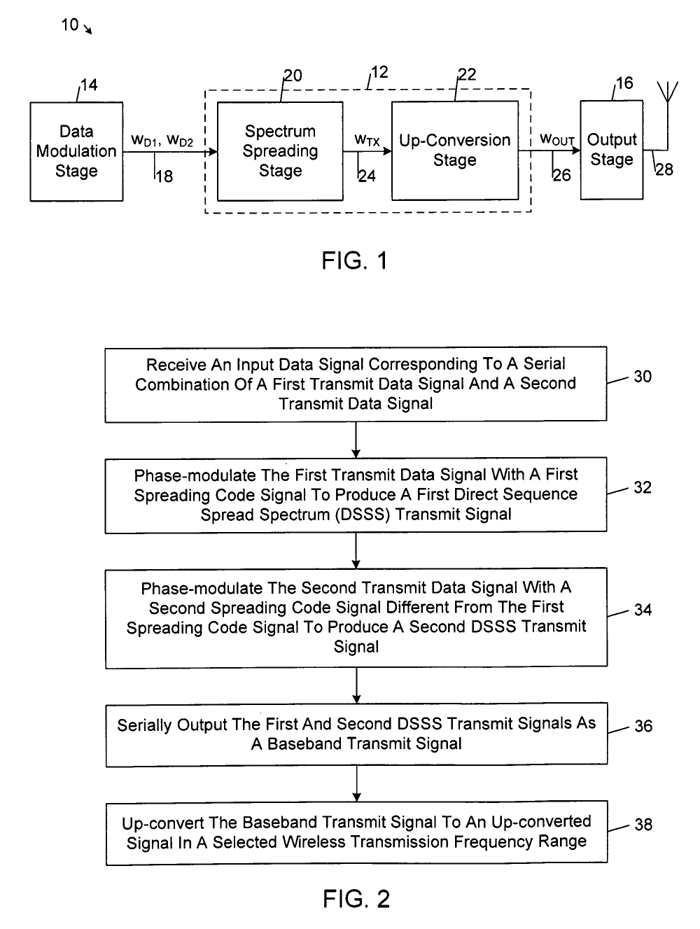

FIG. 1 shows an exemplary application environment 10 in which an embodiment of a wireless transmitter communication apparatus 12 may operate. The application environment 10 includes a data modulation stage 14 and an output stage 16. The data modulation stage 14 produces an input data signal 18 corresponding to a time-interleaved serial combination of a first transmit data signal (w_{D1}) and a second transmit data signal (w_{D1}).

The data modulation stage 14 typically produces the input data signal 18 by modulating a carrier signal, which has a frequency in a baseband frequency range (e.g., between 0 Hz and 100 MHz), with a first data signal and a second data signal in a time-interleaved fashion. In general, the data modulation stage 14 may modulate the first and second data signals onto the carrier signal in accordance with any of a wide variety of different modulation techniques, including amplitude modulation techniques, phase modulation techniques, and frequency modulation techniques. In some embodiments, the data modulation stage 14 modulates the carrier signal in accordance with a phase-shift keyed (PSK) encoding protocol. For example, in some embodiments, the carrier signal is encoded with data in accordance with a differential M-PSK protocol, which uses M phases (corresponding to M equally spaced points on a PSK constellation diagram) to encode log₂M bits per symbol, where M has an integer value of at least two. In some of these embodiments, the carrier signal is encoded with data in accordance with the Differential Binary Phase Shift Keying (DBPSK) protocol (M=2), which is used for 1 Mbps transmissions in accordance with the IEEE 802.11 wireless local area networking protocol. In other embodiments, the carrier signal is encoded with data in accordance with the Differential Quadrature Phase-shift Keying (DQPSK) protocol (M=4).

The wireless communication apparatus 12 includes a spectrum spreading stage 20 and an up-conversion stage 22. The spectrum spreading stage 20 produces a baseband transmit signal 24 (w_{TX}) that corresponds to a serial combination of time-interleaved first and second DSSS signals that are produced from the first and second transmit data signals (w_{D1}, w_{D1}) in accordance with different respective wireless communications protocols. The up-conversion stage 22 up-converts the baseband transmit signal 24 to an up-converted output signal 26 (w_{OUT}) in a selected wireless transmission frequency range. The frequency of the baseband transmit signal 24 is in a specified baseband frequency range, which refers to the frequency range from 0 Hz up to a maximum frequency that is substantially below the wireless transmission frequency range of the up-converted signal 26. In typical RF applications, the maximum baseband frequency typically is below 100 MHz, whereas the maximum frequency of the output signal 26 typically is in the GHz frequency range. The output stage 16 wirelessly transmits the output 26 via an antenna 28.

FIG. 2 shows an embodiment of a wireless communication method that is implemented by the wireless communication apparatus 12.

In accordance with this method, the spectrum spreading stage 20 receives the input data signal 18 from the data modulation stage 14 (FIG. 2, block 30). The input data signal 18 corresponds to a serial combination of the first transmit data signal (w_{D1}) and the second transmit data signal (w_{D1}).

The spectrum spreading stage 20 phase-modulates the first transmit data signal (w_{D1}) with a first spreading code signal to produce a first direct sequence spread spectrum (DSSS) transmit signal (FIG. 2, block 32). The spectrum spreading stage 20 phase-modulates the second transmit data signal (w_{D2}) with a second spreading code signal different from the first spreading code signal to produce a second DSSS transmit signal (FIG. 2, block 34). The spectrum spreading stage 20 serially outputs the first and second DSSS transmit signals as the baseband transmit signal 24 (FIG. 2, block 36). The frequency of the resulting baseband transmit signal 24 is in a specified baseband frequency range (e.g., 0 Hz up to 100 MHz).

The up-conversion stage 22 up-converts the baseband transmit signal 24 (w_{TX}) produced by the spectrum spreading stage 20 to the output signal 26 (w_{OUT}) in a selected wireless transmission frequency range (e.g., 0.5 GHz up to 100 GHz) (FIG. 2, block 38).

In general, the spectrum spreading stage 20 may phase-modulate the first and second transmit data signals (w_{D1}, w_{D2}) with any type of spectrum spreading code signals. Typically, the spectrum spreading code signals correspond to repeating cycles of respective pseudorandom chip (or symbol) sequences. In general, any type of pseudorandom chip sequences may be used to spread the bandwidth of the first and second transmit data signals, including but not limited to Barker codes, m-sequence codes that are generated by feedback shift register generators, Gold codes, and Hadamard-Walsh codes.

In some exemplary embodiments, the first transmit data signal is encoded in accordance with a first communications protocol that corresponds to a standard IEEE 802.11 protocol (e.g., 802.11b or 802.11g), and the second transmit data signal is encoded with a second communications protocol that differs from the first communications protocol only by the use of a different pseudorandom noise chip sequence to modulate the second data signal. In some of these embodiments, the first transmit data signal is modulated by a standard IEEE 802.11 11-chip Barker code (i.e., chip sequence) with a 90.9 nanosecond chip period, and the second transmit data signal is modulated by a different pseudorandom noise code at 90.9 nanoseconds per chip. As explained in detail below, exemplary pseudorandom codes that are suitable for modulating the second transmit data signal include, but are not limited to, chip sequences that are longer or shorter than an 11-chip Barker pseudorandom chip sequence (e.g., a 44-chip sequence, a 22-chip sequence, and a 5-chip sequence).

### B. Exemplary Embodiments of the Spectrum Spreading Stage

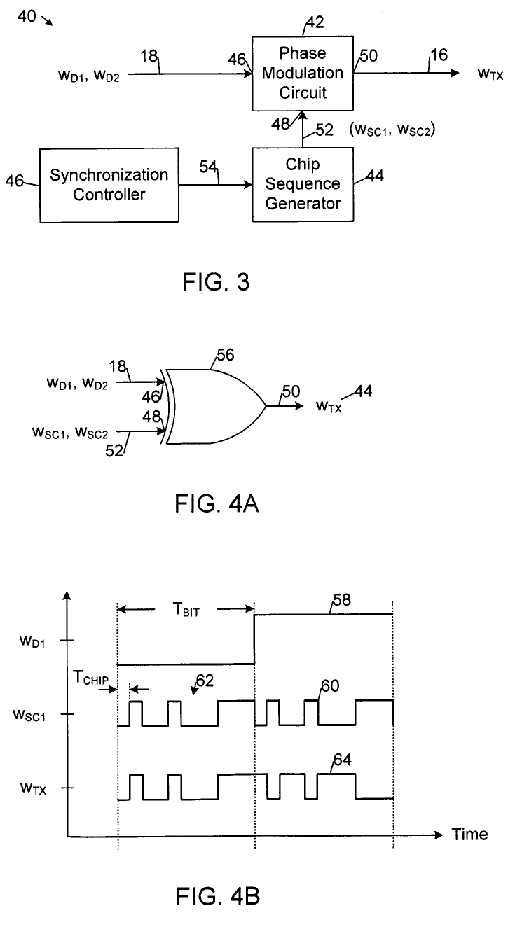

FIG. 3 shows an embodiment 40 of the spectrum spreading stage 20 that includes a phase modulation circuit 42, a chip sequence generator 44, and a synchronization controller 46. The phase modulation circuit 42 has a first input 46 for receiving the input data signal 18, a second input 48 for receiving an output spreading code signal 52 from the chip sequence generator 44, and an output 50 for producing the baseband transmit signal 16 (w_{TX}). The chip sequence generator 44 produces a first spreading code signal (w_{SC1}), produces a second spreading code signal (w_{SC2}), and serially outputs the first and second spreading code signals as the output spreading code signal 52. The synchronization controller 46 produces a synchronization signal 54 that causes the chip sequence generator 44 to produce the first spreading code signal (w_{SC1}) synchronously with the first transmit data signal (w_{D2}) and the second spreading code signal (w_{SC2}) synchronously with the second transmit data signal (w_{D2}). In this way, the phase modulation circuit 46 phase-modulates the first transmit data signal with the first spreading code signal to produce the first DSSS transmit signal and phase-modulates the second transmit data signal with the second spreading code signal to produce the second DSSS transmit signal.

In some embodiments, the phase modulation circuit 42 is a modulo-1 adder, which may be implemented by a logic gate such as an XOR (i.e., exclusive OR) logic gate. The chip sequence generator 44 may be implemented in any of a wide variety of different ways that depends on the type of the first and second spreading code signals (w_{SC1}, w_{SC2}). In general, the chip sequence generator 44 may be implemented in any computing or data processing environment, including in digital electronic circuitry (e.g., a shift register and one or more logic gates, or an application-specific integrated circuit, such as a digital signal processor (DSP)), computer hardware, firmware, device driver, or software. In some embodiments, the synchronization controller 46 is synchronized with at least a part of the carrier signal modulation circuit of the data modulation stage 14 that generates the input data signal 18.

FIG. 4A shows an embodiment of the phase modulation circuit 42 that is implemented by an XOR logic gate 56. FIG. 4B shows a graph of an exemplary set of input signals (w_{D1}, w_{SC1}) that are applied to the inputs 46, 48 of the phase modulation circuit 56 and the resulting output signal (w_{TX}) that is produced at the output 50 of the XOR logic gate 56. The first transmit data signal (w_{D1}) is represented by a binary input signal 58 that is formed of a sequence of bits each of which has a duration of one bit period (T_{BIT}). The first spreading code signal (w_{SC1}) is represented by a binary input signal 60 that is a formed of a sequence of chips each of which has a duration of one chip period (T_{CHIP}). In some exemplary embodiments, the chip period is 90.9 nanoseconds (ns). In the illustrated embodiment, the first spreading code signal (w_{SC1}) includes a string of a first chip sequence 62 (or codeword) that has a duration of one bit period. In this embodiment, the first chip sequence 62 corresponds to an 11-chip Barker code, which is represented by the non-polar chip value sequence “01001000111” or by the non-return-to-zero (NRZ) value sequence +1, −1, +1, +1, −1, +1, +1, +1, −1, −1, −1. The output signal (w_{TX}) is represented by a binary output signal 64, which corresponds to the XOR of the binary input signals 58, 60.

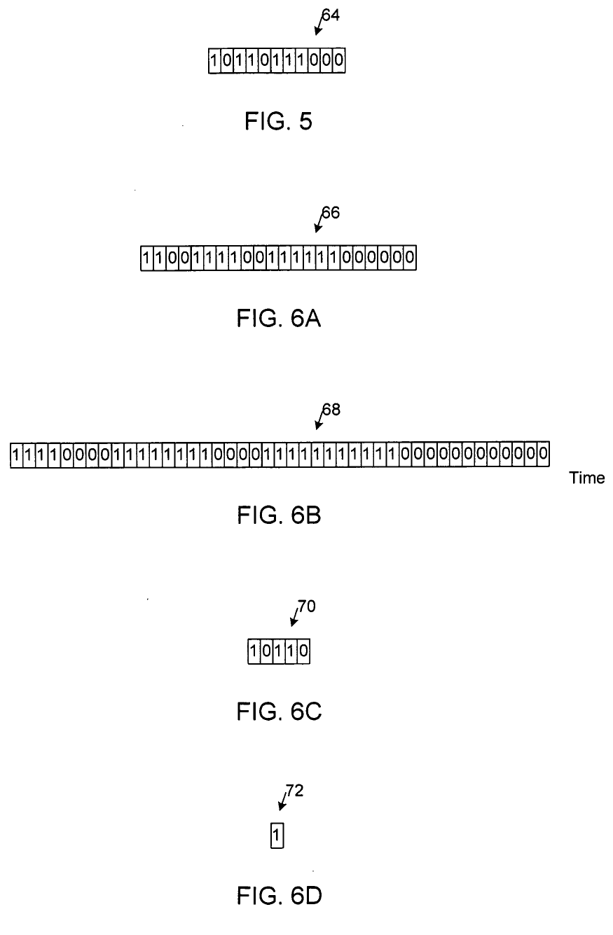

FIG. 5 shows an exemplary chip sequence 64 that may be generated by the chip sequence generator 44. The chip sequence 64 corresponds to the non-polar 11-chip Barker codeword 62 that is described in the preceding paragraph.

FIGS. 6A-6D show exemplary chip sequences 66, 68, 70, 72 that may be generated by the chip sequence generator 44.

The chip sequence 66 corresponds to a 22-chip code that is formed by mapping each successive chip value of the 11-chip Barker code 64 to a respective set of two adjacent chip values of the chip sequence 66. In embodiments in which the chip rates (1/T_{CHIP}) of the chip sequences 64, 66 are the same, the chip sequence 66 produces a DSSS signal with half the data rate of the DSSS signal produced by the chip sequence 64.

The chip sequence 68 corresponds to a 44-chip code that is formed by mapping each successive ship value of the 11-chip Barker code 64 to a respective set of four adjacent chip values of the chip sequence 68. In embodiments in which the chip rates (1/T_{CHIP}) of the chip sequences 64, 68 are the same, the chip sequence 68 produces a DSSS signal with one quarter the data rate of the DSSS signal produced by the chip sequence 64.

The chip sequence 70 corresponds to a 5-chip code that is formed by truncating the 11-chip Barker code 64 after the fifth chip. In embodiments in which the chip rates (1/T_{CHIP}) of the chip sequences 64, 70 are the same, the chip sequence 70 produces a DSSS signal with twice the data rate of the DSSS signal produced by the chip sequence 64.

The chip “sequence” 72 corresponds to a single chip. In embodiments in which the chip rates (1/T_{CHIP}) of the chip sequences 64, 72 are the same, the chip sequence 72 produces a DSSS signal with eleven times the data rate of the DSSS signal produced by the chip sequence 64. In some embodiments, the chip sequence 72 is used for short distance wireless communications where the power is sufficiently low (e.g., less than 0 dBm) that there is no strict requirement of the spreading of the spectrum.

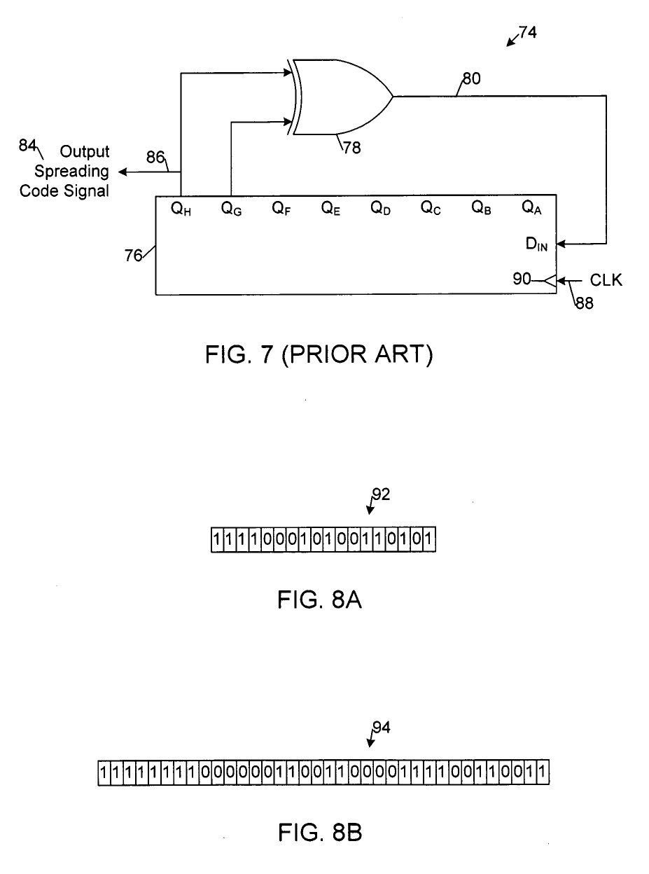

FIG. 7 shows an exemplary embodiment 74 of the chip sequence generator 44 that includes an 8-bit shift register 76 and an XOR logic gate 78. In this embodiment, the XOR logic gate 78 feeds back to the input (D_{IN}) of the shift register 76 a serial input signal 80 that is generated from the exclusive-OR combination of the seventh bit (Q_{G}) and eighth bit (Q_{H}) of the shift register 76. In operation, an output spreading code signal 84 is produced at the output 86 in response to a clock signal 88 that is applied to the clock input 90 of the shift register 76.

FIG. 8A shows an embodiment of a chip sequence 92 that is produced at the output 86 of the chip sequence generator 74 in response to the clock signal 88 with clock pulses occurring at a first clock rate. FIG. 8B shows an embodiment of a second chip sequence 94 that is produced at the output 86 of the chip sequence generator 74 in response to the clock signal 88 with clock pulses occurring at a second clock rate equal to one-half the first clock rate. As shown in FIGS. 8A and 8B, reducing the clock rate by one-half has the same effect as mapping each successive ship value of the chip sequence 92 to a respective set of two adjacent chip values of the chip sequence 94.

### C. Exemplary Embodiments of the Up-Conversion Stage

In general, the up-conversion stage 22 (see FIG. 1) may be implemented by any circuit that is capable of up-converting the baseband transmit signal 24 (w_{TX}) to the selected wireless transmission frequency range. The embodiments that are described in the following paragraphs merely are examples of the types of up-conversion stages that could be used to implement the up-conversion stage 22. In this description, various components (e.g., filter circuits and amplifier circuits), which typically would be included in actual implementations of the up-conversion stage 22, have been omitted to avoid unnecessarily complicating the description with features that are well-known in the art of RF transmitter design.

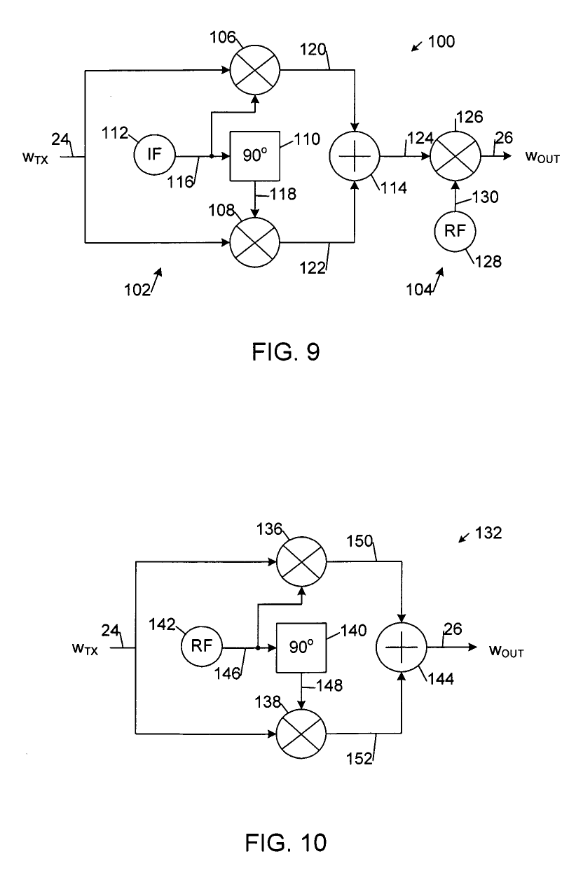

FIG. 9 shows an embodiment 100 of the up-conversion stage 22 that has a superheterodyne transmitter architecture. The up-conversion stage 100 includes an intermediate frequency (IF) up-conversion stage 102 followed by an RF up-conversion stage 104.

The IF up-conversion stage 102 includes a first mixer 106, a second mixer 108, a phase-shifter 110, an IF local oscillator 112, and a summer (or adder) 114. The local oscillator 112 is coupled to the first mixer 106. The phase-shifter 110 is coupled between the local oscillator 112 and the second mixer 108. In operation, the local oscillator 112 produces an in-phase local oscillator signal 116. The phase-shifter 110 produces an in-quadrature version 118 of the local oscillator signal 116 from the in-phase local oscillator signal 116. The first mixer 106 produces the first up-converted signal 120 by mixing the baseband transmit signal 24 with the in-phase local oscillator signal 116. The second mixer 108 produces the second up-converted signal 122 by mixing the baseband transmit signal 24 with the in-quadrature version 118 of the local oscillator signal 116. The summer 114 combines the first and second up-converted signals 120, 122 to produce the IF signal 124.

The RF up-conversion stage 104 includes a mixer 126 and a local oscillator 128. The local oscillator produces a local oscillator signal 130 with a frequency in the selected wireless transmission frequency range. The mixer 126 produces the output signal (w_{OUT}) 26 in the selected wireless transmission frequency range by mixing the IF signal 124 with the local oscillator signal 130.

FIG. 10 shows an embodiment 132 of the up-conversion stage 22 that has a direct conversion transmitter architecture. The up-conversion stage 132 includes a first mixer 136, a second mixer 138, a phase-shifter 140, an RF local oscillator 142, and a summer (or adder) 144. The local oscillator 142 is coupled to the first mixer 136. The phase-shifter 140 is coupled between the local oscillator 142 and the second mixer 138. In operation, the local oscillator 142 produces an in-phase local oscillator signal 146. The phase-shifter 140 produces an in-quadrature version 148 of the local oscillator signal 146 from the in-phase local oscillator signal 146. The first mixer 136 produces the first up-converted signal 150 by mixing the baseband transmit signal 24 with the in-phase local oscillator signal 146. The second mixer 138 produces the second up-converted signal 152 by mixing the baseband transmit signal 24 with the in-quadrature version 148 of the local oscillator signal 146. The summer 144 combines the first and second up-converted signals 150, 152 to produce the output signal 26 (w_{OUT}) in the selected wireless transmission frequency range.

### III. WIRELESS RECEIVER EMBODIMENTS

### A. Overview

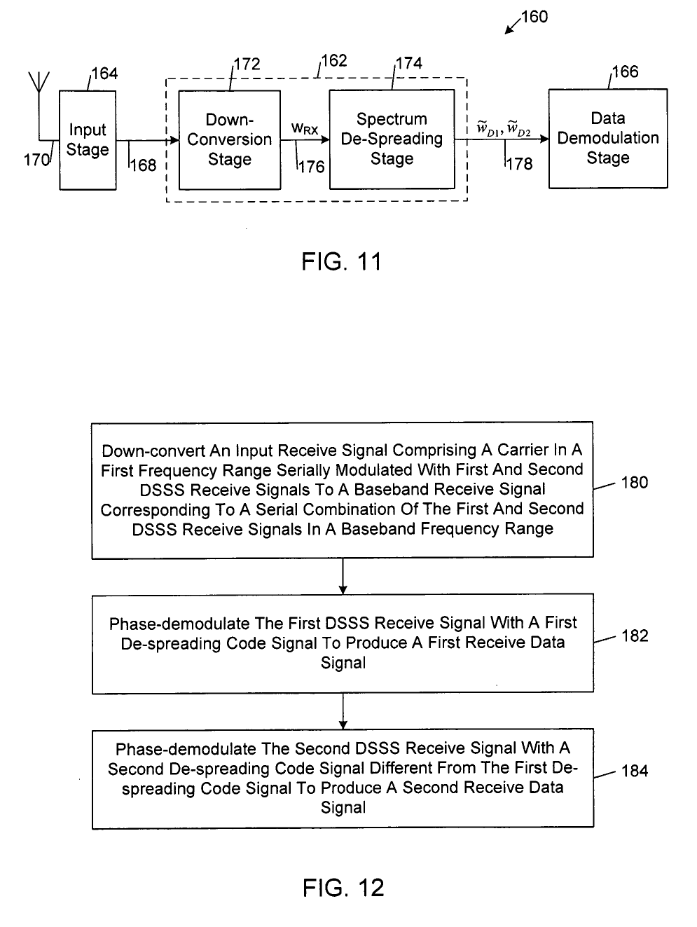

FIG. 11 shows an exemplary application environment 160 in which an embodiment of a wireless receiver communication apparatus 162 may operate. The application environment 160 includes an input stage 164 and a data de-modulation stage 166. The input stage 164 produces an input receive signal 168 from wireless signals that are received by an antenna 170. The input receive signal 168 includes a carrier in a selected wireless reception frequency range (e.g., 0.5 GHz up to 100 GHz) that is serially modulated with time-interleaved first and second DSSS receive signals that are encoded with respective data signals.

The wireless communication apparatus 162 includes a down-conversion stage 172 and a spectrum de-spreading stage 174. The down-conversion stage 172 down-converts the input receive signal 168 from the selected wireless reception frequency range to a baseband receive signal 176 (w_{RX}) in a baseband frequency range. The baseband receive signal 176 is composed of a serial combination of the time-interleaved first and second DSSS receive signals in the baseband frequency range. The baseband frequency range refers to the frequency range from 0 Hertz (Hz) up to a maximum frequency that is substantially below the wireless reception frequency range of the input receive signal 168. In typical RF applications, the maximum baseband frequency typically is below 100 MHz, whereas the maximum frequency of the input receive signal 168 typically is in the GHz frequency range. The spectrum de-spreading stage 174 produces from the baseband receive signal 176 (w_{RX}) a baseband data signal 178 is composed of first and second receive data signals (\tilde{w}_{D1}, \tilde{w}_{D2}).

The data demodulation stage 166 demodulates the baseband baseband data signal 178, which includes the first and second receive data signals (\tilde{w}_{D1}, \tilde{w}_{D2}), to produce output data signals.

FIG. 12 shows an embodiment of a wireless communication method that is implemented by the wireless communication apparatus 162.

In accordance with this method, the down-conversion stage 172 down-converts the input receive signal 168 to the baseband receive signal 176 (FIG. 12, block 180). As explained above, the input receive signal 168 includes a carrier in a first frequency range serially modulated with time-interleaved first and second DSSS receive signals. The baseband receive signal 176 corresponds to a serial combination of the time-interleaved first and second DSSS receive signals in the baseband frequency range.

The spectrum de-spreading stage 174 phase-demodulates the first DSSS receive signal with a first de-spreading code signal to produce the first receive data signal (\tilde{w}_{D1}) (FIG. 12, block 182). The spectrum de-spreading stage 172 also phase-demodulates the second DSSS receive signal with a second de-spreading code signal different from the first de-spreading code signal to produce the second receive data signal (\tilde{w}_{D2}) (FIG. 12, block 184).

### B. Exemplary Embodiments of the Down-Conversion Stage

In general, the down-conversion stage 172 (see FIG. 12) may be implemented by any circuit that is capable of down-converting the input receive signal 168 to the baseband receive signal 176. The embodiments that are described in the following paragraphs are merely examples of the types of down-conversion stages that could be used to implement the down-conversion stage 172. In this description, various components (e.g., filter circuits, amplifier circuits, and baseband processing components), which would be included in actual implementations of the down-conversion stage 172, have been omitted to avoid unnecessarily complicating the description with features that are well-known in the art of RF receiver design.

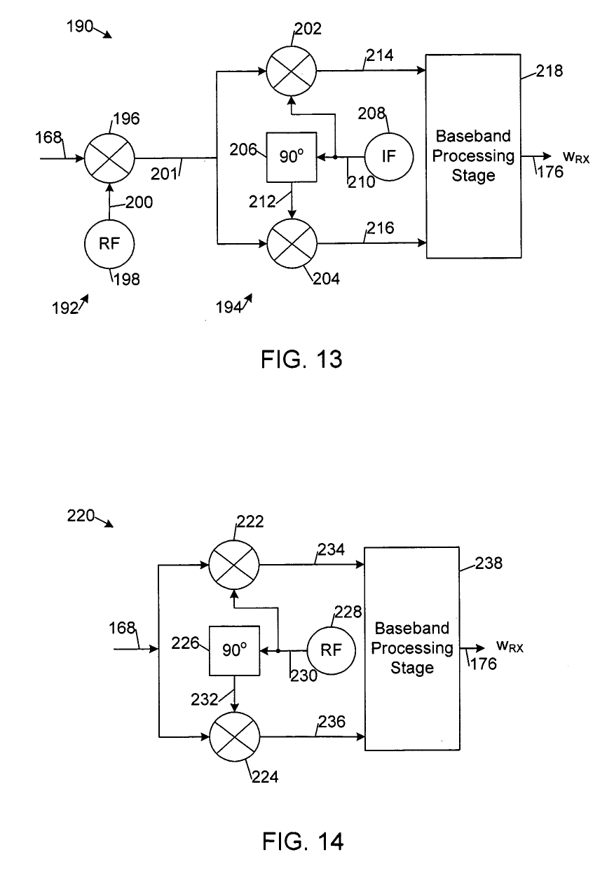

FIG. 13 shows an embodiment 190 of the down-conversion stage 172 that has a superheterodyne transmitter architecture. The down-conversion stage 190 includes an RF down-conversion stage 192 followed by an intermediate frequency (IF) down-conversion stage 194.

The RF down-conversion stage 192 includes a mixer 196 and a local oscillator 198. The local oscillator 198 produces a local oscillator signal 200 with a frequency in the selected wireless reception frequency range. The mixer 196 produces an IF signal 201 in an IF frequency range by mixing the input receive signal 168 with the local oscillator signal 200.

The IF down-conversion stage 194 includes a first mixer 202, a second mixer 204, a phase-shifter 206, and an IF local oscillator 208. The local oscillator 208 is coupled to the first mixer 202. The phase-shifter 206 is coupled between the local oscillator 208 and the second mixer 204. In operation, the local oscillator 208 produces an in-phase local oscillator signal 210. The phase-shifter 206 produces an in-quadrature version 212 of the local oscillator signal 210 from the in-phase local oscillator signal 210. The first mixer 202 produces an in-phase baseband signal 214 by mixing the IF signal 201 with the in-phase local oscillator signal 210. The second mixer 204 produces a quadrature phase baseband signal 216 by mixing the IF signal 201 with the in-quadrature version 212 of the local oscillator signal 210.

A baseband processing stage 218 processes and combines the in-phase and quadrature phase baseband signals 214, 216 to produce the baseband receive signal (w_{RX}) 176.

FIG. 14 shows an embodiment 220 of the down-conversion stage 172 that has a direct conversion transmitter architecture. The down-conversion stage 220 includes a first mixer 222, a second mixer 224, a phase-shifter 226, and an RF local oscillator 228. The local oscillator 228 is coupled to the first mixer 222. The phase-shifter 226 is coupled between the local oscillator 228 and the second mixer 224. In operation, the local oscillator 228 produces an in-phase local oscillator signal 230. The phase-shifter 226 produces an in-quadrature version 232 of the local oscillator signal 230 from the in-phase local oscillator signal 230. The first mixer 232 produces an in-phase baseband signal 234 by mixing the input receive signal 168 with the in-phase local oscillator signal 230. The second mixer 224 produces a quadrature phase baseband signal 236 by mixing the input receive signal 168 with the in-quadrature version 232 of the local oscillator signal 230.

A baseband processing stage 238 processes and combines the in-phase and quadrature phase baseband signals 234, 236 to produce the baseband receive signal (w_{RX}) 176.

### C. Exemplary Embodiments of the Spectrum De-Spreading Stage

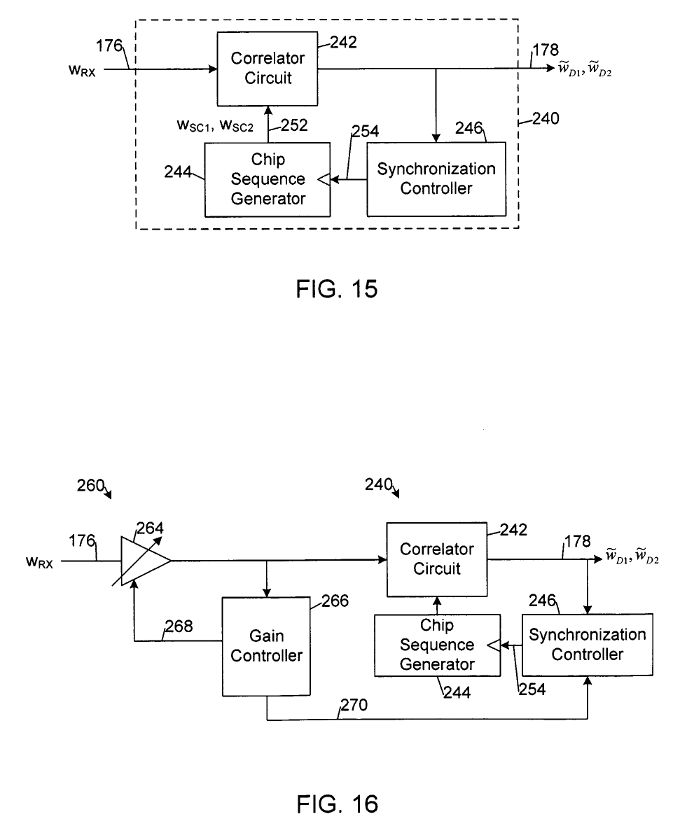

FIG. 15 shows an embodiment 240 of the spectrum de-spreading stage 174 that includes a correlator circuit 242, a chip sequence generator 244, and a synchronization controller 246.

The correlator circuit 242 has a first input for receiving the baseband receive signal (w_{RX}) 176, a second input for receiving first and second de-spreading code signals 252 (w_{SC1}, w_{SC2}) from the chip sequence generator 244, and an output for producing the baseband data signal 178 that is composed of the first and second receive data signals (\tilde{w}_{D1}, \tilde{w}_{D2}).

The chip sequence generator 244 produces the first de-spreading code signal (w_{SC1}) and the second de-spreading code signal (w_{SC2}). The chip sequence generator 244 outputs the first and second de-spreading code signals serially or in parallel. The chip sequence generator 244 may be implemented in any of a wide variety of different ways that depends on the type of the first and second de-spreading code signals (w_{SC1}, w_{SC2}). In general, the chip sequence generator 244 may be implemented in any computing or data processing environment, including in digital electronic circuitry (e.g., a shift register and one or more logic gates, or an application-specific integrated circuit, such as a digital signal processor (DSP)), computer hardware, firmware, device driver, or software.

The synchronization controller 246 produces a synchronization signal 254 that causes the chip sequence generator 244 to produce the first de-spreading code signal (w_{SC1}) synchronously with the first DSSS receive signal and to produce the second de-spreading code signal (w_{SC2}) synchronously with the second DSSS receive signal. In this way, the phase de-modulation circuit 246 phase de-modulates the first DSSS receive signal with the first de-spreading code signal to produce the first receive data signal (\tilde{w}_{D1}) and phase de-modulates the second DSSS receive signal with the second de-spreading code signal to produce the second receive data signal (\tilde{w}_{D2}).

In some embodiments, the correlator circuit 242 is implemented by a matched filter circuit that convolves the baseband receive signal 176 with the first and second de-spreading code signals 252 (w_{SC1}, w_{SC2}) to de-spread the baseband receive signal 176 (w_{RX}). Peaks in the output of the matched filter circuit indicate when one of the first and second de-spreading code signals (w_{SC1}, w_{SC2}) coincides with the corresponding chip sequence in the baseband receive signal. When synchronized, the polarities of the correlation peaks in the output of the matched filter indicate the data values of the receive data signals (\tilde{w}_{D1}, \tilde{w}_{D2}).

In other embodiments, the correlator circuit 242 is implemented by a mixer, an integrate-and-dump circuit, and a threshold detector. In these embodiments, the mixer mixes the first and second de-spreading code signals 252 (w_{SC1}, w_{SC2}) with the baseband receive signal 176. The integrate-and-dump circuit integrates the output of the mixer over the periods of the first and second chip sequences of the first and second de-spreading code signals. The synchronization controller 246 slides the first and second de-spreading code signals 252 (w_{SC1}, w_{SC2}) through the baseband receive signal 176 until the threshold detector indicates that the output of the integrate-and-dump circuit is greater than the threshold, at which point the first and second dispreading code signals 252 (w_{SC1}, w_{SC2}) and the baseband receive signal 176 are deemed to be synchronized.

In some embodiments, the synchronization controller 246 operates in an initial non-coherent detection acquisition mode followed by a tracking mode. In the acquisition mode, the synchronization controller 246 brings the first and second de-spreading signals w_{SC1}, w_{SC2} into coarse alignment respectively with the first and second DSSS receive signals in the baseband receive signal 176. In this process, the baseband receive signal 176 are correlated with the first and second de-spreading code signals 252 (w_{SC1}, w_{SC2}) using, for example, a set of parallel matched filters or a serial sliding correlator circuit. In the tracking mode, the synchronization controller 246 uses a feedback loop (e.g., a delay-locked loop) to maintain a fine alignment between the first and second de-spreading signals w_{SC1}, w_{SC2} and the first and second DSSS receive signals in the baseband receive signal 176.

FIG. 16 shows an embodiment of a gain control stage 260 coupled to the spectrum de-spreading stage 240 (see FIG. 15). The gain control stage 260 includes an amplification circuit 264 and a gain controller 266. The amplification circuit 264 is implemented by a variable gain amplifier whose gain is controlled by a gain control signal 268 that is set by the gain controller 266. The gain controller 266 includes one or more detector circuits that produce measurement signals indicative of the power levels of the baseband receive signal 176. In some implementations, the detector circuits produce DC measurement signals that are proportional to the RMS (root mean square) of the power levels of the baseband receive signal 176. The gain controller 266 sets the gain control signal 268 based on an integration of the differences between the DC measurement signals and one or more reference voltage levels. In some of these implementations, the gain controller 266 produces an output signal 270 that provides measures of the respective power levels of the baseband receive signal 176. In some embodiments in accordance with the invention, the first and second DSSS receive signals are modulated onto the input receive signal 168 at different power levels. In these embodiments, the gain controller output signal 270 is used by the synchronization controller 246 to distinguish the first and second DSSS receive signals from each other. The synchronization controller 246 uses this information to synchronize the generation of the first and second de-spreading code signals w_{SC1}, w_{SC2} by the chip sequence generator 244 with the first and second DSSS receive signals in the baseband receive signal 176.

### IV. EXEMPLARY APPLICATION ENVIRONMENTS AND OPERATING MODES OF THE WIRELESS COMMUNICATION APPARATUS

The following application environments include various networking devices that communicate wirelessly over local area network communications links. At least some of these devices (e.g., the mobile units) incorporate embodiments of the wireless transmitter and receive communications apparatus 12, 152 that are described above. As a result, these “dual-mode” devices are able to communicate with other devices using multiple wireless communications protocols. The wireless transmitter and receiver communications apparatus 12, 162 enable the dual-mode devices to maintain communications links in accordance with multiple wireless communications protocols by switching quickly between the different modes of communication.

In some embodiments, the dual mode devices communicate with suitably configured peripheral devices (e.g., computer mice and keyboards) using a second wireless communications protocol that is different from the IEEE 802.11 protocol. For example, some of these embodiments use a second wireless communications protocol that has the same chip rate as the IEEE 802.11 protocol but has a smaller overhead (e.g., reduced header information) and a different data rate than the IEEE 802.11 protocol. The different data rate is achieved by using a different spectrum spreading code signal to generate the data-carrying DSSS code signals, as explained above.

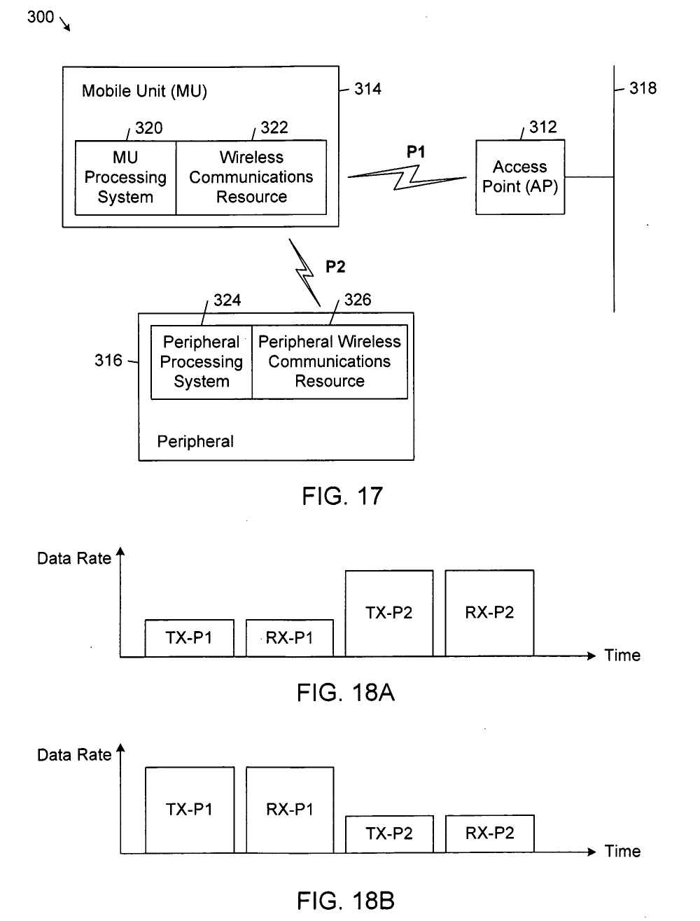

FIG. 17 shows an embodiment of a wireless local area network 300 that includes an access point 312, a mobile unit 314 (MU), and a peripheral 316.

The access point 312 acts as a communications hub for communications between the mobile unit 314 and a wired network 318, which typically is a local area network.

The mobile unit 314 may be implemented by any type of electronic device, including but not limited to desktop computers, laptop and notebook computers, personal digital assistants, and mobile phones. In the illustrated embodiment, the mobile unit 314 includes a processing system 320 and a single wireless communications resource 322. The wireless communications resource 322 includes an RF transceiver that incorporates an embodiment of the wireless transmitter communication apparatus 12, an embodiment of the wireless receiver apparatus 162, and a wireless chipset that includes at least one a communications processor. The processing system 320 configures the wireless communications resource 322 to communicate with the access point 312 in accordance with a first communications protocol (P1) and to communicate with the peripheral 316 in accordance with a second communications protocol (P2) that is different from the first communications protocol (P1). This kind of time multiplexing between different modulation schemes requires the high agility dual-mode wireless transmitter and receiver communication apparatus 12, 162 to be able switch quickly between the two modes and maintain transmission in both systems.

The peripheral 316 may be implemented by any device that is capable of providing input to the mobile unit 314 or presenting output from the mobile unit 314. Examples of input peripherals are computer keyboards, computer mice, touch screens, joysticks, and game controllers. Examples of output peripherals are printers, audio speakers, and monitors. In the illustrated embodiment, the peripheral 316 includes a processing system 324 and a wireless communications resource 326. The wireless communications resource 326 includes an RF transceiver that incorporates an embodiment of the wireless transmitter communication apparatus 12, an embodiment of the wireless receiver apparatus 162, and a wireless chipset that includes at least one a communications processor. The wireless communications resource 326 of the peripheral 316 typically has much less transmission power and computing power capabilities than the wireless communications resource 322 of the mobile unit 314. The processing system 324 configures the wireless communications resource 326 to communicate with the mobile unit 314 in accordance with the second communications protocol (P2).

FIG. 18A shows a graph of data rate plotted as a function of time illustrating a first mode of communication between the mobile unit 314 and the access point 312 and between the mobile unit 314 and the peripheral 326 in the wireless local area network 300 shown in FIG. 17. In accordance with this embodiment, the mobile unit 314 communicates with the access point 312 in accordance with a first communications protocol (P1) that is characterized by a first data rate, and the mobile unit 314 communicates with the peripheral 316 in accordance with a second communications protocol (P2) that is characterized by a second data rate that is higher than the first data rate. In one exemplary implementation of this embodiment, the mobile unit 314 communicates with the access point 312 in accordance with the IEEE 802.11 protocol and uses an N-chip pseudorandom codeword as the spreading code, and the mobile unit 314 communicates with the peripheral 316 in accordance with in accordance with a second wireless communications protocol that is different from the IEEE 802.11 protocol and uses an M-chip pseudorandom codeword as the spreading code, where M is less than N.

FIG. 18B shows a graph of data rate plotted as a function of time illustrating a second mode of communication between the mobile unit 314 and the access point 312 and between the mobile unit 314 and the peripheral 326 in the wireless local area network 300 shown in FIG. 17. In accordance with this embodiment, the mobile unit 314 communicates with the access point 312 in accordance with a first communications protocol (P1) that is characterized by a first data rate, and the mobile unit 314 communicates with the peripheral 316 in accordance with a second communications protocol (P2) that is characterized by a second data rate that is higher than the first data rate. In one exemplary implementation of this embodiment, the mobile unit 314 communicates with the access point 312 in accordance with the IEEE 802.11 protocol and uses an N-chip pseudorandom codeword as the spreading code, and the mobile unit 314 communicates with the peripheral 316 in accordance with in accordance with a second wireless communications protocol that is different from the IEEE 802.11 protocol and uses an M-chip pseudorandom codeword as the spreading code, where M is greater than N.

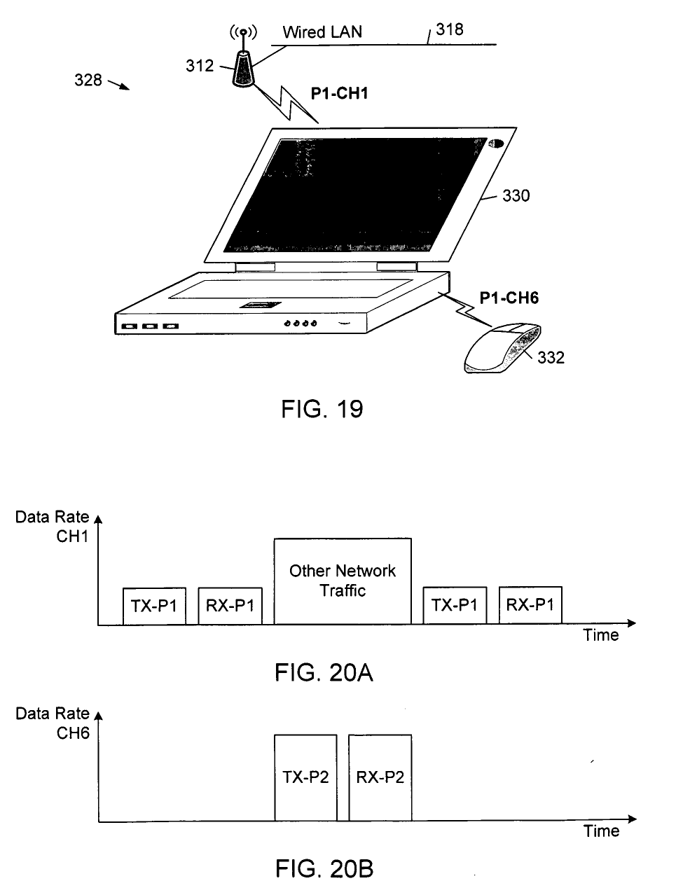

FIG. 19 shows an embodiment 328 of a local area network 300 in which the mobile unit 314 is implemented by a wireless-enabled computer 330 (e.g., a laptop computer) and the peripheral 316 is implemented by a wireless computer mouse 332.

FIGS. 20A and 20B respectively show graphs of data rate plotted as a function of time illustrating different modes of communication between the mobile unit 330 and the access point 312 and between the mobile unit 330 and the peripheral 332 in the wireless local area network 328 (see FIG. 19). In this embodiment, the mobile unit 330 communicates with the access point 312 in accordance with a first communications protocol P1 over a static frequency channel (i.e., CH1) that is established by the access point 312. The mobile unit 330 communicates with the peripheral 332 in accordance with a second communications protocol P2 over an available frequency channel (i.e., CH6) that is different from the static frequency channel. In accordance with this embodiment, the mobile unit 330 switches to the available frequency channel (e.g., CH6) when communicating with the peripheral 332 and thereby enables other devices within the local area network 328 to maintain traffic on the network over the static frequency channel. In one exemplary implementation of this embodiment, the first communications protocol corresponds to the IEEE 802.11 protocol and uses an N-chip pseudorandom codeword as the spreading code, and the second communications protocol is different from the IEEE 802.11 protocol and uses an M-chip pseudorandom codeword as the spreading code, where M is less than N.

In one exemplary implementation in accordance with FIG. 19, the dual-mode wireless communications resource of the computer 330 communicates with the access point 312 using the IEEE 802.11 protocol and then switches to channel 6 to communicate with the computer mouse 332 in accordance with the second wireless communications protocol, allowing the access point 312 to maintain communication with other 802.11 network nodes on channel 1. In this implementation, the switching time is critical: by having a dual radio with short switching time between the different modes, a high network data rate can be maintained.

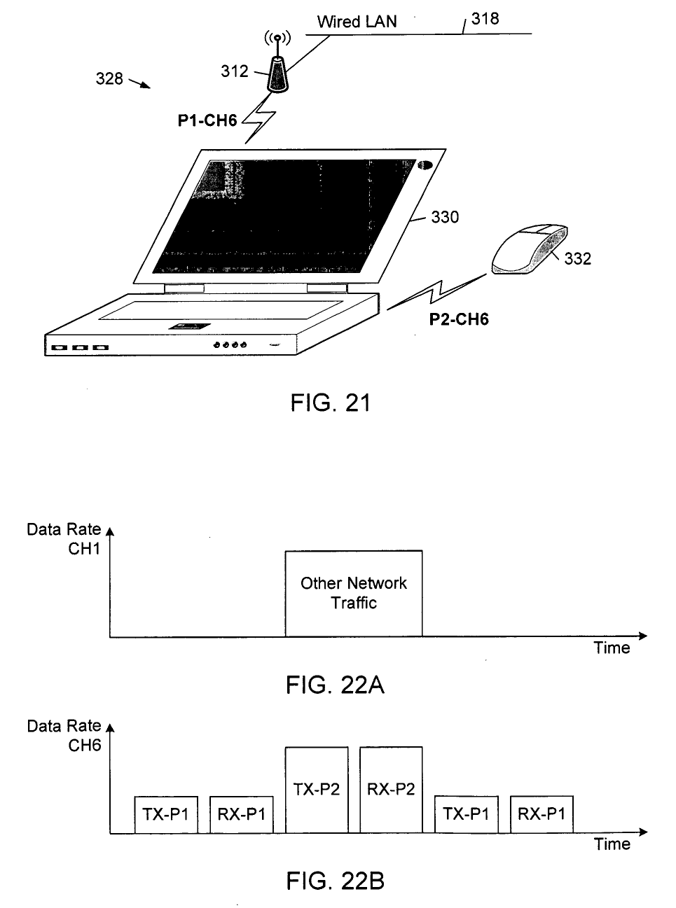

FIG. 21 shows the local area network 328 shown in FIG. 19, where the mobile unit 330 is communicating with access point 312 and the peripheral 332 over the same frequency channel in accordance with different communications protocols.

FIGS. 22A and 22B respectively show graphs of data rate plotted as a function of time illustrating different modes of communication between the mobile unit 330 and the access point 312 and between the mobile unit 330 and the peripheral 332 in the wireless local area network 328 (see FIG. 21). In this embodiment, the access point 312 maintains communications with other network traffic over the static channel (i.e., CH1) in accordance with a first communications protocol (P1). The access point 312 switches to an available frequency channel (e.g., CH6) to communicate with the mobile unit 330. The access point 312 communicates with the mobile unit 330 over the available frequency channel (i.e., CH6) in accordance with the first communications protocol (P1). The mobile unit 330 communicates with the peripheral 332 over the same frequency channel (i.e., CH6) in accordance with the second communications protocol (P2). In one exemplary implementation of this embodiment, the first communications protocol corresponds to the IEEE 802.11 protocol and uses an N-chip pseudorandom codeword as the spreading code, and the second communications protocol is different from the IEEE 802.11 protocol and uses an M-chip pseudorandom codeword as the spreading code, where M is less than N.

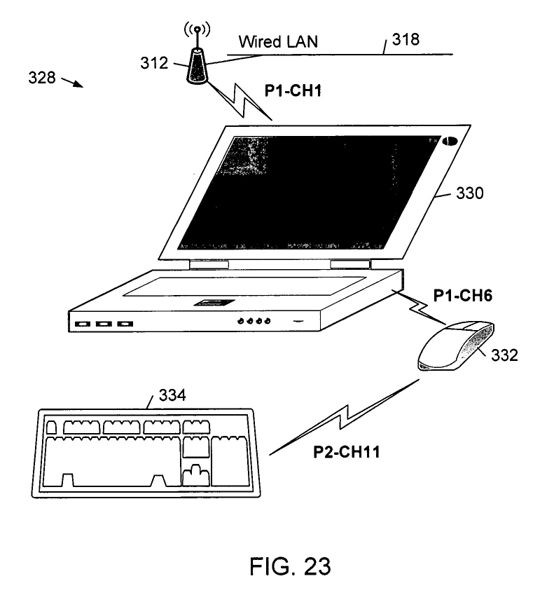

In one exemplary implementation in accordance with FIG. 21, all the traffic between the dual-mode wireless communications resource of the computer 330 and the access point 312 is done on channel 6 using the IEEE 802.11 protocol, leaving channel 1 for dedicated high data rate traffic (such as 802.11g) among other nodes of the local area network. The traffic between the dual-mode wireless communications resource of the computer 330 and the computer mouse 332 occurs on channel 6 in accordance with the second wireless communications protocol. This allows the access point 312 time to switch back to channel 1 and maintain network connectivity. The access point 312 could for example be set to nominally work in channel 1, and switch temporarily to channel 6 in either normal or ad-hoc mode FIG. 23 shows the local area network 328 (see FIG. 21) with a second peripheral 334 (e.g., a wireless keyboard). In this embodiment, the access point 312 communicates with the mobile unit 330 over a first communications channel (i.e., CH1) in accordance with a first communications protocol (i.e., P1). The mobile unit 330 communicates with the first peripheral 332 over a second communications channel (i.e., CH6) in accordance with the first communications protocol (P1). The first peripheral 332 communicates with the second peripheral 334 over a third communications channel (i.e., CH11) in accordance with a second communications protocol (P2).

In some exemplary implementations of the embodiment shown in FIG. 23, the first communications protocol corresponds to the IEEE 802.11 protocol and uses an N-chip pseudorandom codeword as the spreading code, and the second communications protocol is different from the IEEE 802.11 protocol and uses an M-chip pseudorandom codeword as the spreading code, where M is less than N.

In one of these exemplary implementations, the first wireless communications protocol uses an 11-chip Barker spreading codeword and the second wireless communications protocol uses a smaller Barker codeword (e.g., M=5 or M=1). This implementation may save power both with the reduced modulation overhead and the reduced transmission power needed to maintain the communications link between the first and second peripherals 332, 334.

### V. CONCLUSION

The embodiments that are described herein are capable of communicating with multiple wireless environments in accordance with different wireless communications protocols. These embodiments are capable of transmitting and receiving signals that include time-interleaved data-carrying signals that conform to different wireless communications protocols. In particular, the time-interleaved data-carrying signals are direct sequence spread spectrum (DSSS) signals that are produced using different spreading code signals. Some embodiments leverage this feature in novel dual-mode transmitter and receiver architectures in which the same analog components are used to process the different data-carrying signals. In this way, these embodiments are efficient in their use of size and power resources and are able to achieve higher switching speeds relative to approaches that use separate or reconfigurable analog processing channels for the different data-carrying signals.

Other embodiments are within the scope of the claims.

What is claimed is:

1. A wireless communication apparatus, comprising:
a spectrum spreading stage having a data signal input for receiving an input data signal corresponding to a serial combination of a first transmit data signal and a second transmit data signal, the spectrum spreading stage being operable to phase-modulate the first transmit data signal with a first spreading code signal to produce a first direct sequence spread spectrum (DSSS) transmit signal, phase-modulate the second transmit data signal with a second spreading code signal different from the first spreading code signal to produce a second DSSS transmit signal, and serially output the first and second DSSS transmit signals as a baseband transmit signal; and
an up-conversion stage operable to up-convert the baseband transmit signal to an up-converted signal in a selected wireless transmission frequency range.

2. The apparatus of claim 1, wherein:
the spectrum spreading stage comprises a chip sequence generator operable to produce the first spreading code signal, produce the second spreading code signal, and serially output the first and second spreading code signals as an output spreading code signal; and
the spectrum spreading stage has a spectrum spreading signal input for receiving the output spreading code signal from the chip sequence generator and is operable to phase-modulate the input data signal with the output spreading code signal to produce the baseband transmit signal.

3. The apparatus of claim 2, further comprising a controller operable to synchronize the chip sequence generator with the input data signal so that the spectrum spreading stage phase-modulates the first transmit data signal with the first spreading code signal and phase-modulates the second transmit data signal with the second spreading code signal.

4. The apparatus of claim 3, wherein the input data signal comprises a carrier signal encoded with a sequence of bits each having a duration of one bit period, the first spreading code signal comprises a string of a first chip sequence having a first duration, and the second spreading code signal comprises a string of a second chip sequence different from the first chip sequence and having a second duration.

5. The apparatus of claim 4, wherein the chip sequence generator produces the first spreading code signal with the first chip sequence consisting of a first number of chips and produces the second spreading code signal with the second chip sequence consisting of a second number of chips different from the first number of chips, wherein the chips of the first and second chip sequences have equal chip periods and the durations of the first and second chip sequences are different.

6. The apparatus of claim 4, wherein the chip sequence generator comprises a chip sequence generator circuit that generates the first spreading code signal in response to a clock signal with pulses occurring at a first clock rate and generates the second spreading code signal in response to the clock signal with pulses occurring at a second clock rate different from the first clock rate.

7. The apparatus of claim 4, wherein the chip sequence generator generates the second spreading code signal by mapping each successive chip value of the first chip sequence to a respective successive set of M adjacent chip values of the second chip sequence, which contains M−1 times more chips than the first chip sequence, where M has an integer value of at least two.

8. The apparatus of claim 1, further comprising:
a down-conversion stage operable to down-convert an input receive signal comprising a carrier in a first frequency range serially modulated with first and second time-interleaved DSSS receive signals to a baseband receive signal corresponding to a serial combination of the first and second time-interleaved DSSS receive signals in a baseband frequency range; and
a spectrum de-spreading stage having an input for receiving the baseband receive signal and being operable to phase-demodulate the first DSSS receive signal with a first de-spreading code signal corresponding to a replica of the first spreading code signal to produce a first receive data signal and to phase-demodulate the second DSSS receive signal with a second de-spreading code signal corresponding to a replica of the second spreading code signal to produce a second receive data signal.

9. The apparatus of claim 8, wherein:
the spectrum de-spreading stage comprises a second chip sequence generator operable to produce the first de-spreading code signal and the second de-spreading code signal; and
the spectrum de-spreading stage receives the first and second de-spreading code signals from the second chip sequence generator and is operable to phase-demodulate the baseband receive signal with the first and second de-spreading code signals to produce the first and second receive data signals.

10. The apparatus of claim 9, further comprising a second controller operable to synchronize the second chip sequence generator with the baseband receive signal so that the spectrum de-spreading stage phase-demodulates the first DSSS receive signal with the first de-spreading code signal and phase-demodulates the second DSSS receive signal with the second de-spreading code signal.

11. A wireless communication method, comprising:
receiving an input data signal corresponding to a serial combination of a first transmit data signal and a second transmit data signal;
phase-modulating the first transmit data signal with a first spreading code signal to produce a first direct sequence spread spectrum (DSSS) transmit signal;
phase-modulating the second transmit data signal with a second spreading code signal different from the first spreading code signal to produce a second transmit DSSS signal;
serially outputting the first and second DSSS transmit signals as a baseband transmit signal; and
up-converting the baseband transmit signal to an up-converted signal in a selected wireless transmission frequency range.

12. The method of claim 11, further comprising: producing the first spreading code signal; producing the second spreading code signal; and serially outputting the first and second spreading code signals as an output spreading code signal;
wherein the phase-modulating of the first and second transmit data signals comprises phase-modulating the input data signal with the output spreading code signal to produce the baseband transmit signal.

13. The method of claim 12, further comprising synchronizing the output of the first and second spreading code signals with the input data signal so that the first transmit data signal is phase-modulated with the first spreading code signal and the second transmit data signal is phase-modulated with the second spreading code signal.

14. The method of claim 13, wherein:
the input data signal comprises a carrier signal encoded with a sequence of bits each having a duration of one bit period;
the first spreading code signal comprises a string of a first chip sequence having a duration of one bit period;
the second spreading code signal comprises a string of a second chip sequence different from the first chip sequence and having a duration of one bit period;
the producing of the first spreading code signal comprises producing the first spreading code signal with the first chip sequence consisting of a first number of chips; and
the producing of the second spreading code signal comprises producing the second spreading code signal with the second chip sequence consisting of a second number of chips different from the first number of chips.

15. The method of claim 13, wherein:
the input data signal comprises a carrier signal encoded with a sequence of bits each having a duration of one bit period;
the first spreading code signal comprises a string of a first chip sequence having a duration of one bit period;
the second spreading code signal comprises a string of a second chip sequence different from the first chip sequence and having a duration of one bit period;
the producing of the first spreading code signal comprises generating the first spreading code signal in response to a clock signal with pulses occurring at a first clock rate; and
the producing of the second spreading code signal comprises generating the second spreading code signal in response to the clock signal with pulses occurring at a second clock rate different from the first clock rate.

16. The method of claim 13, wherein:
the input data signal comprises a carrier signal encoded with a sequence of bits each having a duration of one bit period;
the first spreading code signal comprises a string of a first chip sequence having a duration of one bit period;
the second spreading code signal comprises a string of a second chip sequence different from the first chip sequence and having a duration of one bit period;
the producing of the second spreading code signal comprises generating the second spreading code signal by mapping each successive chip value of the first chip sequence to a respective successive set of M adjacent chip values of the second chip sequence, which contains M−1 times more chips than the first chip sequence, where M has an integer value of at least two.

17. A wireless communication apparatus, comprising:
a down-conversion stage operable to down-convert an input receive signal comprising a carrier in a first frequency range serially modulated with first and second time-interleaved DSSS receive signals to a baseband receive signal corresponding to a serial combination of the first and second time-interleaved DSSS receive signals in a baseband frequency range; and
a spectrum de-spreading stage having an input for receiving the baseband receive signal and being operable to phase-demodulate the first DSSS receive signal with a first de-spreading code signal to produce a first receive data signal and to phase-demodulate the second DSSS receive signal with a second de-spreading code signal different from the first de-spreading code signal to produce a second receive data signal.

18. The apparatus of claim 17, wherein:
the spectrum de-spreading stage comprises a chip sequence generator operable to produce the first de-spreading code signal and produce the second de-spreading code signal; and
the spectrum de-spreading stage receives the first and second de-spreading code signals from the chip sequence generator and is operable to phase-demodulate the baseband receive signal with the first and second de-spreading code signals to produce the first and second receive data signals.

19. The apparatus of claim 18, further comprising a controller operable to synchronize the chip sequence generator with the baseband receive signal so that the spectrum de-spreading stage phase-demodulates the first DSSS receive signal with the first de-spreading code signal and phase-demodulates the second DSSS receive signal with the second de-spreading code signal.

20. The apparatus of claim 17, wherein further comprising a gain controller operable to produce output signals indicative of power levels of the baseband receive signal, and further comprising a synchronization controller operable to distinguish the first and second DSSS receive signals from each other based on the output signals produced by the gain controller.

21. A wireless communication method, comprising:
down-converting an input receive signal comprising a carrier in a first frequency range serially modulated with first and second time-interleaved DSSS receive signals to a baseband receive signal corresponding to a serial combination of the first and second time-interleaved DSSS receive signals in a baseband frequency range;
phase-demodulating the first DSSS receive signal with a first de-spreading code signal to produce a first receive data signal; and
phase-demodulating the second DSSS receive signal with a second de-spreading code signal different from the first de-spreading code signal to produce a second receive data signal.
